(19) United States
(12) Patent Application Publication
(10) Pub. No.: US 2020/0275188 A1
(43) Pub. Date: Aug. 27, 2020

(54) STORAGE UTENSIL FOR BLUETOOTH EARPHONE

(71) Applicant: TIEN-CHIAO CHANG, HSINCHU COUNTY (TW)

(72) Inventor: TIEN-CHIAO CHANG, HSINCHU COUNTY (TW)

(21) Appl. No.: 16/720,964

(22) Filed: Dec. 19, 2019

(30) Foreign Application Priority Data
Feb. 25, 2019 (TW) 108202371

(51) Int. Cl. H04R 1/10; H04R 5/033

(52) U.S. Cl. CPC H04R 1/1041; H04R 5/033; H04R 2430/01; H04R 2420/07; H04R 1/1025

(57) ABSTRACT

The invention provides a kind of storage utensil for Bluetooth earphone, including one bearing component, one charging unit and one switching unit, the bearing component could be used for placing the Bluetooth earphone, which is equipped with a resonance part and several speaking out openings, the resonance part could provide the Bluetooth earphone for exporting the sound wave for resonating to achieve the effect of loudspeaker, the speak out opening is connected to the resonance part for exporting the sound effect, the charging unit is installed on the bearing component, which could charge for the Bluetooth earphone, the switching device is installed on the bearing component and electrically connected to the charging unit so that it could switch and receive the Bluetooth earphone signal and transmit the amplified Bluetooth signal to the Bluetooth earphone for producing voice when the Bluetooth headphone is charging.

### BACKGROUND OF INVENTION

### 1. Field of the Invention

This invention is relevant to the Bluetooth earphone, and more particularly to be more exact, it is a kind of storage utensil for Bluetooth earphone.

### 2. Description of Related Art

There are many types of well-known earphones. For example, there are wired earbuds earphone, wireless earbuds earphone (Bluetooth), wireless hook up earphones (Bluetooth), headphone and Bluetooth headphone, etc. The headphone is in an integrated design for the Bluetooth earphone and loudspeaker (voice box) to wear on the head and make use of two ear shields covering the ears. Besides possessing the function of Bluetooth earphone, it could also switch to the loudspeaker mode for listening to the music (the way of switching is to flip up the ear shields. There are many related commodities and patents. We will not discuss the detailed structure one by one.

The well-known wired earbuds earphone, wireless earbuds earphone or wireless hook up earphone are in smaller size. While it is not used, it is easier for placing into the bags or boxes from the manufacturers. The headphone and Bluetooth headphone are of bigger size and there is fewer manufacturer providing the bags or boxes for storing. In most cases, many people place them on the furniture like the tables, cabinets or chairs, etc., where it is convenient for taking. Those kinds of way for placing make the earphone is easier for absorbing the moisture, pollution or damaging

Secondly, most of wireless earphones make use of Bluetooth module for wireless connection among different types of wireless earphone in the market. It requires the power for driving the Bluetooth module. It is necessary to charge when the power is not enough. In the current market, there are storage boxes for charging the earphone with the function of storing and charging. However, there is no such kind of earphone storage utensil that could be used both for the storing and charging for those earphones with bigger size.

Moreover, the earphone storage utensil possessing the function for both the storing and charging under the current quick scientific development. In the future, it shall not be able to satisfy the consumer's needs for the product with multi-functions.

### SUMMARY OF THE INVENTION

The main purpose of this invention is to provide a kind of storage utensil for Bluetooth earphone, which shall possess not only storing but also charging the earphone. It could further be changed to the voice box to bring the function that the well-known earphone storage utensils do not possess.

Hence, the invention provides a kind of Bluetooth earphone storage utensil to include a bearing component for storing the Bluetooth earphone in order to achieve the above-mentioned purpose, above that, it is equipped with a resonance part with several speaking out openings, this resonance part could export the earphone's sound wave for resonance to achieve the effect of voice box, the speak out openings connects with the resonance part to export the sound effect, a charging unit is installed on the bearing component, including electrically connecting to several batteries and charging components, the charging component could charge for the Bluetooth earphone, a switching device is installed on the bearing component, which is connected to the charging unit for switching and receiving the Bluetooth signal from the Bluetooth headphone while in charging, the could further amplify the Bluetooth signal to the Bluetooth earphone to produce the sound.

### BRIEF DESCRIPTION OF THE DRAWINGS

FIG. 1 is the electrical system diagram for the best implementation of invention.

FIG. 2 is the 3D external view of bearing component for the best implementation of invention.

FIG. 3 is the application status figure for the best implementation of invention.

FIG. 4 is the application of the 2nd best implementation of invention.

FIG. 5 is the application status figure for the 3rd best implementation of invention.

FIG. 6 is the application status figure for the 4th best implementation of invention.

FIG. 7 is the breakdown figure for the 4th best implementation of invention.

### DETAILED DESCRIPTION OF THE INVENTION

In order to clearly explain the above-mentioned purpose and function that the invention could achieve, it attaches the figures to detail explain several best implementations with features and functions.

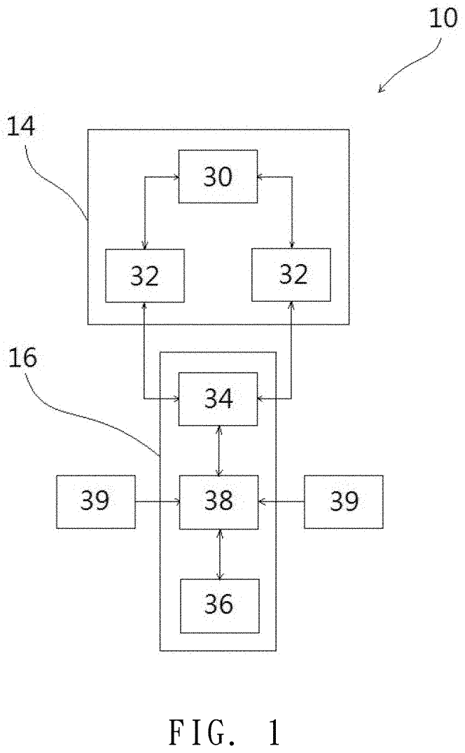

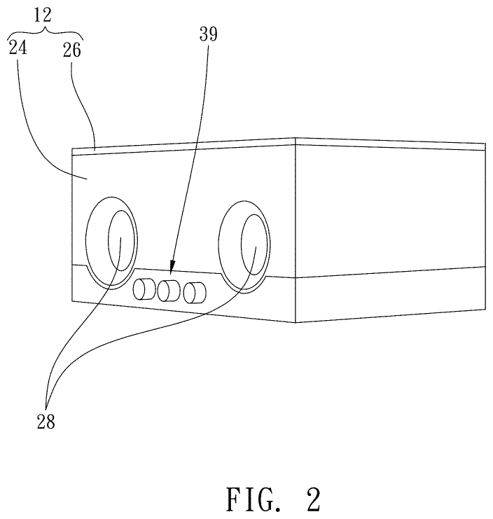

First, refer to the indication from FIGS. 1 and 2, the Bluetooth earphone storage utensil (10) is the best implementation of invention, which includes a bearing component (12), a charging unit (14) and a switching device (16).

The bearing component (12) is a box. It is constituted by one opening on the top of (24) one cover (26). Inside the shell (24), it forms a space for resonance (resonant cavity), which could store one Bluetooth headphone (1). Its cover (26) could be flipped up or covered by connecting to the top of shell (24). The front side of shell (24) is equipped with two speaking out openings (28). Its resonance part could export the Bluetooth headphone's (1) sound wave to produce the effect of voice box. Those two speak out openings (28) could export the sound effect. The Bluetooth headphone (1) is a well-known Bluetooth earphone for integrating the Bluetooth earphone and loudspeaker.

The charging unit (14) includes the electrical connection of at least one battery (30) and two charging units (32). This battery (30) is installed inside the shell (24). Those two charging components (32) are in pin, which is installed at the bottom of shell (24). It is in corresponding to the position of two speaking out openings (28). Two charging components (32) could be correspondingly connected to two head shields (2) (voice boxes) of Bluetooth headphone (1) for charging when storing to the resonance part.

The switching device (16) includes the electrical connection to one switching unit (34), one Bluetooth unit (36) and one amplifying unit (38). The switching unit (34) is in a well-known switching circuit, which is electrically connected to the charging component (32) to cut off the Bluetooth earphone's signal and start the Bluetooth signal from the Bluetooth unit (36) so that the Bluetooth signal could be transmitted to the Bluetooth earphone (1) for producing the voice after the amplification by amplifying unit (38) when connecting to the Bluetooth headphone (1) for charging. The Bluetooth unit (36) is a well-known Bluetooth module. Its amplifying unit (38) is a well-known amplifying module (or called amplifier).

Besides, the outside of bearing component (12) is equipped with several knobs (39), which are connected to the amplifying unit (38). The later one is the knobs for adjusting the volume, low-pass and high-pass of amplifier, which could be used for adjusting the amplifying unit (38) to further adjust the volume and tone from the Bluetooth headphone (1).

Whereby, the using method, features and functions of invented Bluetooth earphone storage utensil (10) are as follows:

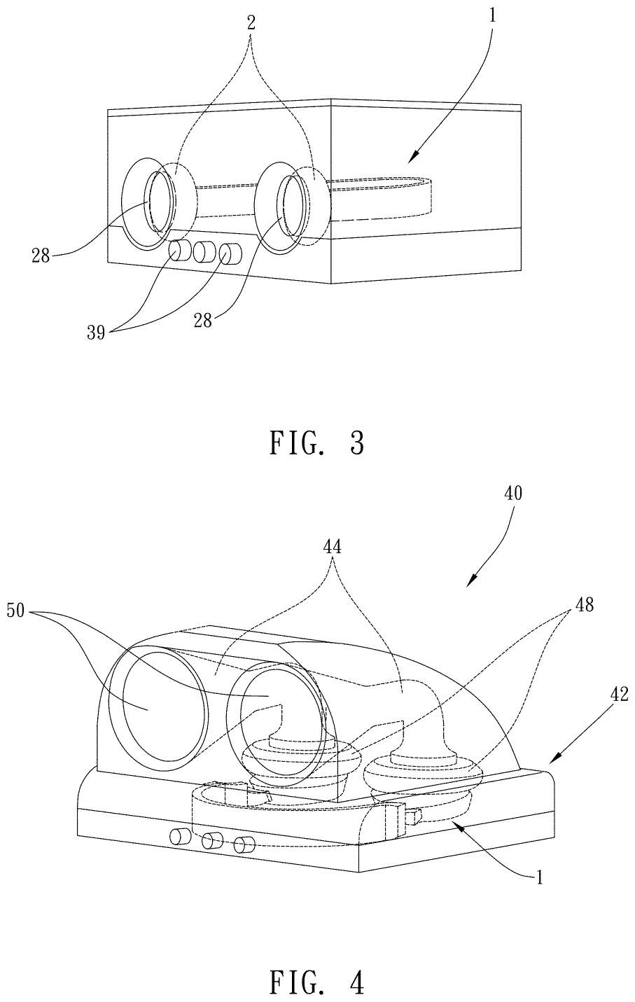

As shown in FIG. 3, you could place the Bluetooth earphone into the bearing component (12) when you are using the Bluetooth headphone (1) for playing the music but not wishing to continue wearing on the head. You could further correspondingly insert those two charging components (32) to two ear shields (2) of Bluetooth headphone (1) for charging.

Furthermore, the switching device (16) could interrupt the receiving of Bluetooth signal and start the receiving of Bluetooth signal of Bluetooth unit (36) to transmit the Bluetooth signal to the Bluetooth headphone (1) for playing music through the amplifying unit (38) when charging for the Bluetooth headphone. And the music from the Bluetooth headphone could produce the resonance inside the resonance part and further be exported through speaking out opening (28). Then the bearing component (12) likes the voice box for sound. Those two ear shields (2) of Bluetooth headphone (1) like the loudspeaker for sound for turning the Bluetooth earphone storage utensil into the voice box.

In another words, the Bluetooth headphone storage utensil (10) could also ingeniously turning its storage space for Bluetooth headphone (1) into the voice box besides its storage for Bluetooth headphone (1) and charging batteries. It could produce the function that the well-known headphone storage utensil does not possess with practical value.

As shown in FIG. 4, the Bluetooth earphone storage utensil (40) is the 2^{nd} best implementation of invention. Its structure is roughly the same as the Bluetooth earphone storage utensil (10). The difference is that its bearing component (42) is in box. The bottom of internal resonance part (44) is equipped with storage space that could open or close for storing the Bluetooth headphone (1). The space of resonance part (44) is connected through one port (48). The music played could pass through this port (48) to the resonance part (44) for resonating when the Bluetooth headphone (1) is placed in the storing space. It is exported from one side of resonance part (44) to speaking out opening (50). Then, the Bluetooth headphone could make use of the storing space for charging through the electrical component (52) when the Bluetooth headphone (1) is stored in the space. It makes the Bluetooth headphone achieving the above-mentioned effect of Bluetooth earphone storage utensil.

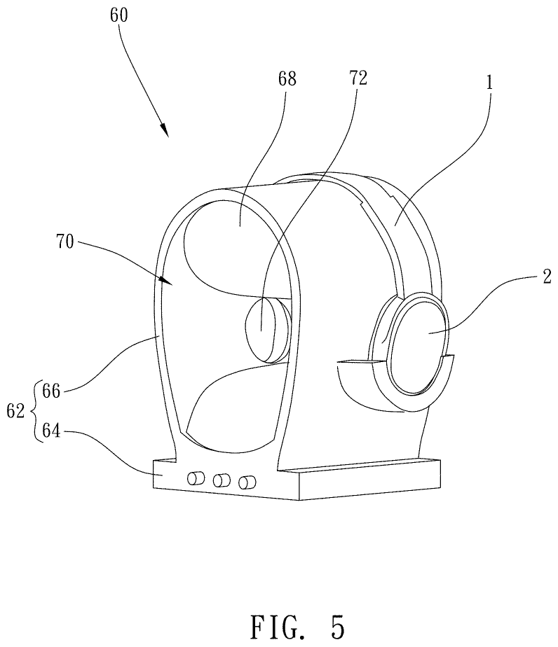

As shown in FIG. 5, the Bluetooth earphone storage utensil (60) is the 3^{rd} best implementation of invention. Its difference on structure is that its bearing component (62) includes one stand (64) and one shelf (66). Its shelf is in arch shape and installed on the top side of stand (64) for the formation of resonance (68) inside. Its two ends form the speaking out opening (70). Its Bluetooth headphone (1) could be directly installed on the top side of shelf (66) while its two ear shields could correspondingly connect to the opening (72) at both sides of shelf (66). It could connect to the charging component, which is not shown on the figure by connecting to the shelf (66). Then the music played from its two ear shields could achieve the resonating in resonance part (68) from its two openings (72) to the inside of shelf (66). It could achieve the above-mentioned effect from the Bluetooth earphone storage utensil (60).

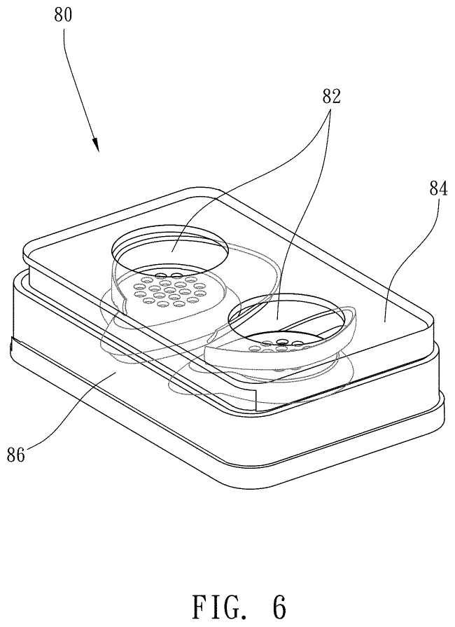

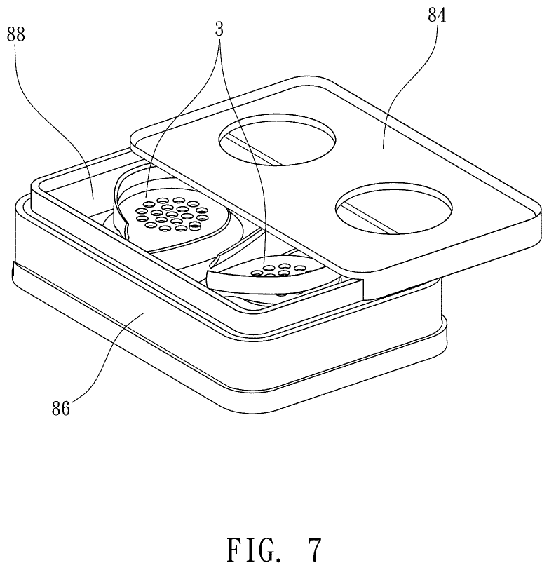

Also, the invention of Bluetooth earphone storage utensil could store the hook up Bluetooth earphone. As shown in FIGS. 6 and 7, the Bluetooth earphone storage utensil (80) is the 4^{th} best implementation of invention. Its structure likes the Bluetooth earphone storage utensil. Its difference is that those two speak out openings (82) are installed on the cover (84), which could be flipped up and closed on the top of shell (86). Two earphones (3) of hook up Bluetooth earphone could be placed inside two chambers (88 and 89) inside the shell (86). Its charging unit and switching device are installed at the bottom of a chamber (88), which are not shown in the figure. So, it could achieve the above-mentioned function for Bluetooth earphone storage utensil (80).

From the above, we could see that the Bluetooth earphone storage utensil provided through our creativity depends on the coordination with bearing component, charging unit as well as the switching device, which could not only for storing the headset, hook up Bluetooth earphone device but also charging while in Bluetooth earphone storage. At the same time, it could transmit the Bluetooth signal to the Bluetooth earphone for producing the voice through the device switching device and signal amplification. It could further change to the acoustic type with the headset and hook up Bluetooth earphone collection, charging as well as the function for changing the acoustics with practical value through the resonance of bearing component in the resonance part.

There is one thing needs to be indicated is that the structure of charging unit is not limited to the above-mentioned pin type but also be the type of USB cable or even the wireless charging module. It is in conformance with the indication of invention if it could provide the charging to the Bluetooth earphone while in storing, which is in the technical scope of invention.

While the means of specific embodiments in the present invention have been described by reference drawings, numerous modifications and variations could be made thereto by those skilled in the art without departing from the scope and spirit of the invention set forth in the claims. The modifications and variations should be in a range limited by the specification of the present invention.

What is claimed is:

1. A storage utensil for Bluetooth earphone, comprising:
a bearing component, which could provide the storing of Bluetooth earphone, equipped with a resonance part and several speak out openings, the resonance part could provide the Bluetooth earphone to export the sound wave for resonance to produce the effect of voice box, the speak out openings are connected to the resonance part for exporting the sound effect;
a charging unit, which is installed on the bearing component, including the electrical connection with several batteries and charging components, the charging components could charge for the Bluetooth earphone, and
a switching device, which is installed on the bearing component and electrically connected to the charging unit for charging the Bluetooth earphone, could switch and receive the Bluetooth signal of Bluetooth earphone and then amplify the Bluetooth signal and transmit to the Bluetooth earphone for producing the voice when the charging component implementing charging for the Bluetooth earphone.

2. The storage utensil for Bluetooth earphone defined in claim 1, wherein said bearing component is in a kind of box with its internal forming a resonance part, the Bluetooth earphone is stored in the resonance part, the speak out openings are at one side of bearing component and the charging component is installed at the inside of bearing component corresponding to the position for speak out opening.

3. The storage utensil for Bluetooth earphone defined in claim 2, wherein said bearing component includes a shell with the opening at the top, the internal space inside the shell forms a resonance part with one piece for flipping and closing the cover on the opening at the top of shell. Its Bluetooth earphone is inside the shell with two speak out openings at one side of shell.

4. The storage utensil for Bluetooth earphone defined in claim 1, wherein said bearing component includes an opening at the top of shell, the internal space inside the shell forms a resonance part with one piece for flipping and closing the cover on the opening at the top of shell, the Bluetooth earphone is inside the shell with two speak out openings at one side of shell.

5. The storage utensil for Bluetooth earphone defined in claim 1, wherein said bearing component is in a box form. Its inside is equipped with a resonance part and a storing space. Its resonance part and storing space are connected by several openings, the Bluetooth earphone is stored in the storing space, the speak out opening is set at one side of bearing component. Its charging component is installed inside the storing space.

6. The storage utensil for Bluetooth earphone defined in claim 1, wherein said bearing component includes one stand and one shelf, the shelf is in arch shape and installed on the stand, which could be used for placing the Bluetooth earphone on the top, the inside forms a resonance part with speak out openings at two ends and two openings at both ends, the two openings are in corresponding to two ear shields of Bluetooth earphone, the charging component is set on the stand.

7. The storage utensil for Bluetooth earphone defined in claim 1, wherein said charging component is in pin type.

8. The storage utensil for Bluetooth earphone defined in claim 2, wherein said charging component is in pin type.

9. The storage utensil for Bluetooth earphone defined in claim 3, wherein said charging component is in pin type.

10. The storage utensil for Bluetooth earphone defined in claim 4, wherein said charging component is in pin type.

11. The storage utensil for Bluetooth earphone defined in claim 5, wherein said charging component is in pin type.

12. The storage utensil for Bluetooth earphone defined in claim 6, wherein said charging component is in pin type.

13. The storage utensil for Bluetooth earphone defined in claim 1, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

14. The storage utensil for Bluetooth earphone defined in claim 2, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

15. The storage utensil for Bluetooth earphone defined in claim 3, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

16. The storage utensil for Bluetooth earphone defined in claim 4, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

17. The storage utensil for Bluetooth earphone defined in claim 5, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

18. The storage utensil for Bluetooth earphone defined in claim 6, wherein said switching device includes the electrical connection to one switching unit, one Bluetooth unit and one amplifying unit, the switching unit is electrically connected to the charging component, which is used for cutting off the Bluetooth earphone receiving the Bluetooth signal and start the Bluetooth unit receiving the Bluetooth signal when the Bluetooth earphone connecting to the charging unit, the Bluetooth signal could be transmitted to the Bluetooth earphone for producing voice through the amplifying unit.

19. The storage utensil for Bluetooth earphone defined in claim 3, wherein the outside of bearing component is equipped with several knobs electrically connected to the amplifying unit, which could adjust the volume and sound quality of Bluetooth earphone.

20. The storage utensil for Bluetooth earphone defined in claim 4, wherein the outside of bearing component is equipped with several knobs electrically connected to the amplifying unit, which could adjust the volume and sound quality of Bluetooth earphone.
